(19) United States
(12) Patent Application Publication
(10) Pub. No.: US 2014/0224589 A1
(43) Pub. Date: Aug. 14, 2014

(54) LIFTER

(71) Applicants: Arnold Vetter, Wilnsdorf (DE); David Lueckhof, Dillenburg (DE)

(72) Inventors: Arnold Vetter, Wilnsdorf (DE); David Lueckhof, Dillenburg (DE)

(21) Appl. No.: 14/175,140

(22) Filed: Feb. 7, 2014

(30) Foreign Application Priority Data
Feb. 13, 2013 (DE) 102013002406.4

(51) Int. Cl. B66F 9/12

(52) U.S. Cl. CPC B66F 9/12
USPC 187/237

(57) ABSTRACT

The object of the invention is a lifter for a material-handling truck, in particular, a fork (1) for an industrial truck, comprising at least one fork arm having a shank (2) and a blade attached to the shank, a folding shoe (6) being pivotal on the free outer end of the blade (3) opposite the shank (2) in such a way that pivoting of the fork shoe (6) proceeds reliably whenever forces occur that have a component toward the blade, thereby preventing the load from being damaged and eliminating the possibility of damage, including environmental damage and injury to personnel. To achieve this object, at least one longitudinal guide (8) extending along the blade (3) is provided in at the free outer end of the blade (3) for at least one slide (9) that at least in part projects from the free end of the blade (3), the folding shoe (6) being rotatably supported on the outer end of the slide (9), the blade (3) and the fork shoe (6) each having at least one pivot (13, 14) on at least slightly different planes, at least one push rod (7) being disposed between the pivot (13) of the blade (3) and the pivot (14) of the folding shoe (6).

The invention relates to a lifter for a material-handling truck, in particular, forks for industrial trucks, comprising at least one fork arm that has a shank and a blade attached to the shank, wherein a folding shoe is rotatably supported on the free end of the blade opposite the shank.

Fork arms of this type including integrated folding shoes or tips function to protect the load from being damaged.

During normal use, the folding shoe can rest on the blade and for example can be fit into pallet openings provided for this purpose. In response to the outer end of the folding shoe's unintentionally contacting the load or the pallet, the folding shoe folds up. The shoe here is rotated approximately 90°, thereby enlarging the contact area of the fork arm with the load. As a result, the surface pressure is diminished and possible penetration of or damage to the load is prevented.

A fork arm of this type including integrated folding shoe is disclosed in WO 2011/048576 [U.S. 2012/0211308]. However, the folding shoe here is attached to the outer end of the blade in such a way that not every unintended contact by the folding shoe outer end with the load results in folding of the shoe. Whenever forces on the folding shoe come into play that do not act precisely in the longitudinal direction of the blade, there is a risk that the folding shoe will not fold over reliably. The outer end of the fork arm can bore into the load. Where for example canisters filled with propellant gas are involved, this can lead to explosions and considerable damage, including injury to personnel.

A forklift fork is disclosed in DE 10 2011 121 329 that is equipped with a shock-absorber that converts the mechanical energy acting in the longitudinal direction of the fork arms at least partially into internal energy. No provision is made for enlarging the surface area of the fork outer end relative to the load. After the mechanical energy has been converted to internal energy, the fork outer end unintentionally moves into the load, which can result in high economic loss, and possibly cause damage to the environment and endanger personnel.

The object of the invention is to develop a lifter for a material-handling truck so that the folding of the fork shoe occurs reliably whenever forces are applied that have a force component toward the blade, thereby preventing the load from being damaged and eliminating the possibility of damage, including environmental damage and injury to personnel.

In order to achieve this object, at least one longitudinal guide extending along the blade is provided for at least one slide that in part projects from the free end of the blade, the folding shoe being rotatably supported on the outer end of the slide, the blade and the fork shoe each having at least one pivot on at least slightly different planes, at least one push rod being provided between the pivot of the blade and the pivot of the folding shoe.

Forces acting on the folding shoe toward the blade cause the slide to move within its guide. However, the push rod between the blade and the shoe cannot follow this longitudinal movement. The pivots that are on different planes, however, force the folding shoe to pivot about the pivot axis at the outer end of the slide, and the folding shoe is folded from its rest position to a protective position. The increasing shortening of travel for the pivot point between the slide and the shoe relative to the attachment points of the push rods on the blade causes the push rod, and thus the folding shoe, to pivot up.

As a result, the surface area acting on the load is increased from the outer end of the folding shoe with its small area to the large area of the entire folding shoe that now acts on the load. As a result, the folding shoe can no longer penetrate into the load and cause any damage there.

An advantageous aspect is the fact that a spring associated with the slide biases the slide away from the shank.

The action of this spring enables the folding shoe also to retract again after the at least one component of the force diminishes toward the blade. Conversely, the action of the spring causes the folding shoe to be biased in one direction. No unintentional deployment of the folding shoe or flapping motion by the folding shoe on the blade is possible when the material handling truck travels, for example over uneven ground.

An approach has proven successful whereby one compression spring and/or a hydraulic and/or pneumatic spring is provided as the spring.

The spring can easily be provided between the longitudinal guide and the slide to generate the desired biasing.

It should be noted that the longitudinal guide can be a flat guide and/or a V-shaped guide and/or a dovetail guide and/or round guide.

The guides could be accommodated within the blade in protected fashion such that only a small part of the free end of the slide projects by its pivot out of the blade. This protects the guides from contamination and possible wear.

Another aspect that enhances the protection of the guides is that the folding shoe is of U-section and opens downward so that the folding shoe essentially surrounds the free end of the blade when in the rest position.

An important aspect is that a push rod is associated with each of the two legs of the U-section shoe, and that the push rods along with the slide, which is guided within the longitudinal guide, and the folding shoe form a parallelogrammatic linkage.

This ensures a reliable, jamming-free folding deployment of the folding shoe when forces are present that have components acting toward the blade.

The following describes the invention in more detail with reference to a drawing. Therein:

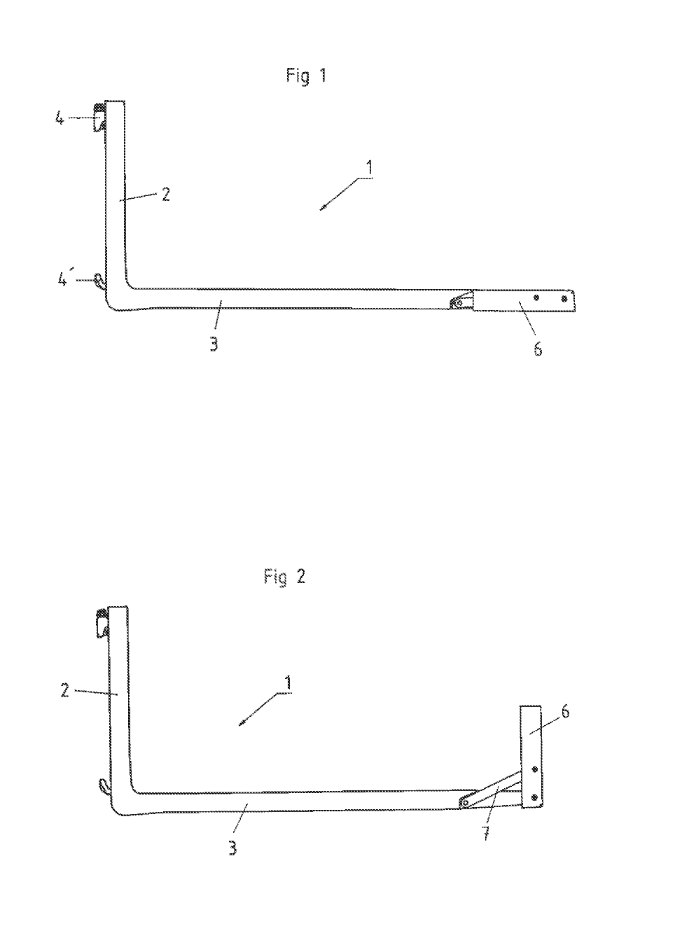

FIG. 1 is a side view of a fork arm according to the invention in the rest position;

FIG. 2 is a side view of a fork arm according to the invention with the folding shoe in the actuated position;

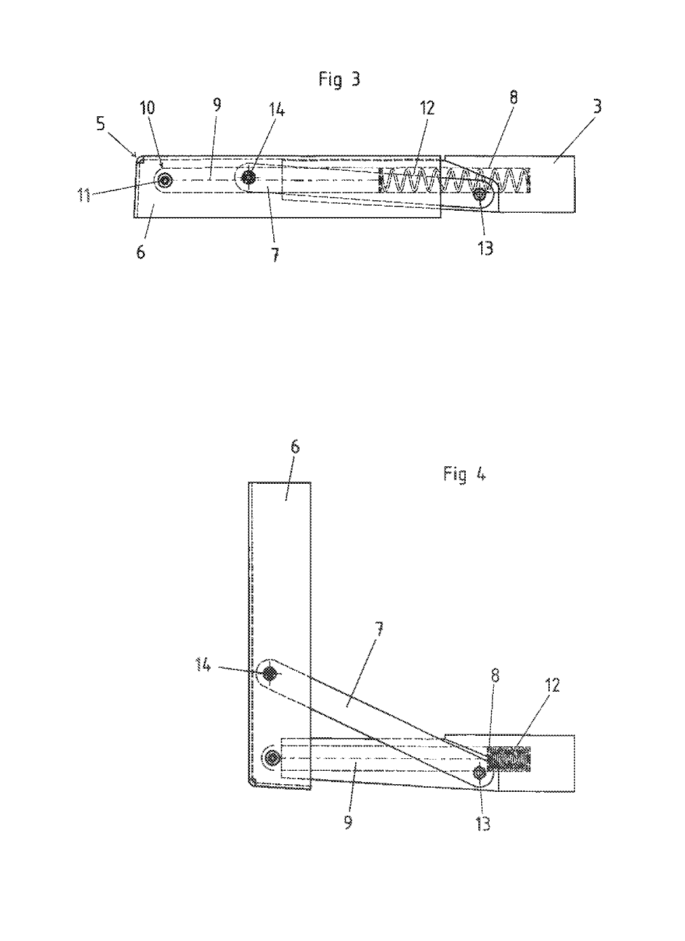

FIG. 3 is a cutaway view of the outer end of the fork arm according to the invention when in the rest position; and

FIG. 4 is a cutaway view of the outer end of the fork arm with folding shoe in the active position.

FIG. 1 shows a fork 1 that is formed by a shank 2 and a blade 3. Hooks 4, 4′ on the shank serve for attachment of the fork 1 to a support of a material-handling truck. A folding shoe 6 is mounted at the outer end of the blade 3.

FIG. 2 shows the same fork 1 according to the invention where, however, the folding shoe 6 has been rotated from the rest position in FIG. 1 to the active position of FIG. 2. FIG. 2 also shows one of the two push rods 7 that are provided one behind the other.

FIG. 3 is a cutaway view of the blade 3. A longitudinal guide slot 8 is formed in the blade 3 in which an element 9 is longitudinally slidable. The shoe 6 is pivotal about an axis 11 at the outer end 10 of the slide 9. The slide 9 is biased by a spring 12 outward away from the blade 3. The push rod 7, which is mounted at its rear end on a pivot 13 on the blade 3 and is connected at its front end by a second pivot 14 to the folding shoe 6, prevents the slide 9 from moving out of the longitudinal guide 8. An essential aspect is that the rear pivot 13 is below a plane of the front pivot 14 so that the angled push rod 7 pivots up the folding shoe 6 whenever an inward force is exerted on the outer end 5 of the folding shoe 6 toward the blade 3, which force longitudinally slides the slide 9 in the longitudinal guide 8 against the force of the spring 12.

FIG. 4 shows how the folding shoe 6 pivots. The spring 12 is shown compressed. The slide 9 has essentially retracted into the longitudinal guide 8, while the push rod 7 has pivoted up.

Together with the folding shoe, the one push rod 7 or two push rods 7 one behind the other, and the slide 9 create a parallelogrammatic linkage that always causes the shoe 6 to be raised reliably.

Reference list

| | | | |
|---|---|---|---|
| 1 | fork | 9 | slide |
| 2 | shank | 10 | tip |
| 3 | blade | 11 | pivot |
| 4 | fork hook | 12 | spring |
| 5 | tip | 13 | pivot |
| 6 | folding shoe | 14 | pivot |
| 7 | push rod | | |
| 8 | longitudinal guide | | |

1. A lifter for a forklift truck, comprising:
at least one fork arm that has a shank and a blade attached to the shank,
a folding shoe pivotally mounted on a free outer end of the blade opposite the shank,
at least one longitudinal guide extending along the blade (3) is provided in the free outer end of the blade, (3) for
at least one slide and projecting at least in part from the free end of the blade, the folding shoe being pivotal on the outer end of the slide the blade and the fork shoe each having at least one pivot on at least slightly offset planes, and
at least one push rod connected between the pivot of the blade and the pivot of the folding shoe.

2. The lifter according to claim 1, further comprising:
at least one spring engaging the slide and biasing the slide away from the shank.

3. The lifter according to claim 2, wherein the spring is a compression spring or a pneumatic spring or a hydraulic spring.

4. The lifter according to claim 1, wherein the longitudinal guide (8) is a flat guide and/or a V-shaped guide or dovetail guide or a round guide.

5. The lifter according to claim 1, wherein the folding shoe is of U-section and opens downward and the folding shoe surrounds the free end of the blade when in the rest position.

6. The lifter according to claim 5, wherein a respective push rod is associated with each of the two legs of the U-section shoe, and that the push rods together with the slide guided within the longitudinal guide and the folding shoe form a parallelogrammatic linkage.

7. A forklift fork comprising:
a horizontal blade having an outer end adapted to be inserted into a slot of a load;
a horizontal guide in the blade open at the outer end;
a slide movable horizontally in the guide and having an outer end and an inner end;
a spring in the guide bearing outward on the slide inner end and biasing the slide outward;
a shoe pivoted about a horizontal shoe axis transverse to the guide on the slide outer end between a horizontal rest position extending parallel to the blade and an upright actuate position extending transverse to the blade;
an inner pivot on the blade and defining a horizontal axis transverse to the guide;
an outer pivot on the shoe between the inner and outer ends thereof and defining an axis parallel to the inner-pivot axis; and
a rigid push rod having inner and outer ends pivoted on the inner and outer pivots and of such a length that inward movement of the outer end of the slide pivots the shoe from the horizontal rest position and the upright actuated position.

8. The fork defined in claim 7, wherein the axes are all parallel and perpendicular to the guide.

9. The fork defined in claim 7, wherein the shoe is of U-section and fits downwardly over the blade in the rest position.

10. The fork defined in claim wherein the shoe axis moves in a plane on sliding of the slide in the guide, the outer pivot axis being to one side of the plane and the inner pivot axis being to the opposite side of the plane.
